(19) United States
(12) Patent Application Publication
(10) Pub. No.: US 2010/0062670 A1
(43) Pub. Date: Mar. 11, 2010

(54) POLYMERIC COMPOSITION COMPRISING POLYOEFINS AND ALIPHATIC-AROMATIC COPOLYESTERS

(75) Inventors: Catia Bastioli, Novara (IT); Roberto Marangon, Novara (IT)

Correspondence Address: CONNOLLY BOVE LODGE & HUTZ LLP, 1875 EYE STREET, N.W., SUITE 1100, WASHINGTON, DC, 20006, US

(73) Assignee: NOVAMONT S.P.A., Novara (IT)

(21) Appl. No.: 12/520,507

(22) PCT Filed: Dec. 20, 2007
(86) PCT No.: PCT/EP2007/064399

§ 371 Date: Jun. 19, 2009

(30) Foreign Application Priority Data
Dec. 21, 2006 (IT) MI2006A002469

(51) Int. Cl. C08L 67/02; D04H 13/00; C08K 3/26; C08K 3/34; C08K 3/22; C08K 11/00; B29C 51/00

(52) U.S. Cl. 442/327; 525/177; 524/513; 524/427; 524/451; 524/447; 524/432; 524/13; 524/15; 264/241

(57) ABSTRACT

Polymeric composition comprising a polyolefin and a diacid-diol aliphatic-aromatic copolyester with aromatic part consisting mainly of terephthalic acid or its derivatives, aliphatic part consisting of azelaic acid, sebacic acid and brassylic acid and diol C₂-C₁₃. Said copolyesters are particularly compatible with polyolefins, in particular with isotactic polypropylene, in the absence of compatibilising agents.

The present invention concerns a polymeric composition comprising polyolefins and aromatic aliphatic copolyesters with improved dyeability, paintability and mass colourability.

In particular the present invention refers to binary compositions of isotactic polypropylene with aliphatic-aromatic copolyesters of the diacid diol type able to improve performance of the polyolefin in terms of paintability of moulded components, colourability of fibres and improvement of fibre strength.

The products obtained from said compositions are particularly useful in the field of fibres and fabrics, but also have many applications in the field of injection moulding and foamed materials. The compositions of the invention are furthermore useful for obtaining blown films for bi-oriented films and many other applications.

It is known that polyolefins are polymers not compatible with the majority of polymers. Due to their low surface tension, they have poor compatibility with the majority of known polymers and are thus also difficult to paint and colour. For example polypropylene fibres are generally mass-coloured. Unlike polyester fibres, which are woven neutral and then coloured, polypropylene fibres, since they are mass-coloured, give rise to serious warehouse management problems. Furthermore it is known that the above-mentioned incompatibility represents one of the biggest problems for the recylability of polyolefins.

The techniques for increasing the surface tension, and therefore the paintability or colourability of polyolefins, consists above all in modifying them by means of copolymerisation techniques which involve the insertion of polar blocks such as, for example, ethylene-vinylacrylate or, as in the case of polypropylene, grafting of polyacrylates. These modifications limitate the performance of the polyolefins. Another method is blending with non-olefinic polymers in the presence of specific compatibilising agents such as polyethylene vinylacetate (WO06-064732).

It has now been discovered that aliphatic-aromatic copolyesters of the diacid-diol type with aromatic part consisting mainly of terephthalic acid or its derivatives, aliphatic part consisting a diacid monomer selected from C₉-C₁₃, particularly azelaic acid, sebacic acid and brassylic acid or their mixtures, and diol C₂-C₁₃, preferably C₂-C₄, even more preferably C₄, are particularly compatible with polyolefins, in particular with isotactic polypropylene, in the absence of compatibilising agents.

In particular the aliphatic-aromatic copolyesters have an aromatic acid content with respect to the total acid content of between 30 and 80%, preferably between 45 and 60%.

In particular, the present invention refers to a polymeric composition comprising, with respect to the total weight of the composition:
polyolefin in quantity of 60-99.5% preferably of 80-99%;
biodegradable aliphatic-aromatic copolyesters of the diacid diol type in quantity of 0.5-40% preferably of 1-20%;
   characterized in that the biodegradable aliphatic-aromatic copolyesters contain an aromatic part consisting mainly of terephthalic acid or its derivatives, an aliphatic part consisting of a diacid monomer selected from C₉-C₁₃, particularly azelaic acid, sebacic acid and brassylic acid and their mixtures, and diol C₂-C₁₃, preferably C₂-C₄, even more preferably C₄, such as butanediol.

In the composition according to the present invention the preferred polyolefin is isotactic polypropylene.

In a preferred embodiment of the present invention the biodegradable aliphatic-aromatic copolyesters have an aromatic acid content with respect to the total acid content between 30 and 80%, preferably between 45 and 60%.

The compatibility between copolyesters and polypropylene is so high as to permit spinnability of binary mixtures of polypropylene and copolyester in conditions similar to those of the polypropylene as such.

Said fibres are furthermore surprisingly dyeable with dyes of various types showing a dyeability equivalent to that of polyesters. The coloured fibres also have excellent colour fastness to light. Particularly noticeable is that the dyeing process of these fibres can be performed at temperatures less than 130° C., preferably less than 100° C.

Furthermore since the copolyesters of the compositions according to the invention have self-extinguishing properties in themselves, the compositions can be self-extinguishing without the need to add flameproof additives.

The biodegradable copolyesters forming part of the composition according to the present invention can be polymerised via polycondensation. Furthermore the copolyesters can be branched via the introduction of polyfunctional monomers such as glycerine, epoxidised soya oil, trimethylolpropane and similar or polycarboxylic acids such as butantetracarboxylic acid. The copolyesters can also be supplemented with chain extenders such as difunctional, trifunctional or tetrafunctional anhydrides like maleic anhydride, trimellitic or pyromellitic anhydride, with polyepoxides, aliphatic and aromatic isocyanates.

The composition according to the invention, or the individual components of the same, can be regraded with isocyanates in the molten state, at the end of the polymerisation reaction or in the extrusion phase, or in the solid state, as described for example in the patent application Novamont WO 99/28367. The binary composition or the individual components thereof can also be supplemented with chain extenders or cross-linking agents of the above types in the mixing phase.

Various additives such as antioxidants, UV stabilisers, thermal stabilisers and stabilisers against hydrolysis, flame retardants, slow release agents, inorganic and organic fillers, for example natural fibres, antistatic agents, wetting agents, colourants and lubricants can also be added to the composition.

In particular, in the production of films by blowing or flat sheet die, as is or bi-oriented, the following can be added: silica, calcium carbonate, talc, kaolin, kaolinite, zinc oxide, various wollastonites and in general lamellar inorganic substances, functionalised or otherwise with organic molecules, capable of splitting into lamellae during mixing with the polymeric mixture or with one of the individual polymers of the mixture to produce nanocomposites with improved antiblocking and barrier properties. The various inorganic substances can be used in a mixture or as individual products. The concentration of the inorganic additives is generally between 0.05 and 70%, preferably between 0.5 and 50%, even more preferably between 1 and 30%.

In the case of natural fibres and fillers such as cellulose fibre, sisal, hazelnut meal, corncobs, rice chaff, soya and similar and their mixtures, the preferred concentrations range from 0.5 to 70%, more preferably from 1 to 50%. It is also possible to load the binary mixtures with mixed inorganic and vegetable fillers.

To improve the filmability characteristics, amides of aliphatic acids can be added such as oleamide, stearamide, erucamide, behenamide, N-oleylpalmitamide, Nstearyl-erucamide and other amides; salts of fatty acids such as aluminium stearate, zinc stearate and calcium stearate, and similar. The quantities of these additives vary from 0.05 to 7 parts and preferably between 0.1 and 5 parts of the polyolefin and copolyester composition.

The compositions according to the present invention can also be used to obtain fibres for fabrics and non-woven fabrics, or for fishing nets. Furthermore the non-woven fabric can be used in the sector of nappies, sanitary towels, carpet fibres, for stuffing etc. The fibres can also be used as reinforcing fibres in special paper.

The composition according to the invention can be advantageously used also for the production of sheet for thermoforming, monoextruded or coextruded with other layers of polymers and then thermoformed into trays for food, containers for agriculture and other.

### EXAMPLES

### Example 1

90% homopolymer isotactic polypropylene (MFI=25), 10% polybutylene sebacate-co-terephthalate (39% sebacic-−61% terephthalic); MFR=10 at 190° C. and 2.16 kg) are fed into a polypropylene spinning plant under the following conditions:
extruder thermal profile: 230-230-230-230° C.
duct: 230° C.
head: 230° C.
godet A: 525 m/min (heated to 50° C.)
godet B: 780 m/min (heated to 120° C.)
godet C: 1653 m/min (heated to 125° C.)
godet D: 1517 m/min (this spooler relay godet is not heated)
spooler speed: 1500 m/min
working pressure: 70 bar
extruder speed: 17.7 RPM
extruder motor absorption: 12.7 A
spinning pump: 6.5 RPM
3 threading dies with 2×25 round holes, diameter 0.65 mm (6 den/filament yarn)

The fibres obtained were dyed (1 kg of fibres in 20 kg of colouring solution) using 1.5% blu foron E5R as colourant.

The dyeing temperature used was 115° C. showing optimal dyeability equivalent to the fibres of the pure polybutylen sebacate-co-terephthalate and excellent colour fastness to light.

### Example 2

94% homopolymer isotactic polypropylene (MFI=25), 6% polybutylen sebacate-co-terephthalate (39-61% sebacic acid-terephthalic acid; MFR=10 at 190° C. and 2.16 kg) are fed into a polypropylene spinning plant under the same conditions of Example 1.

The fibres obtained were dyed (1 kg of fibres in 20 kg of colouring solution) using 1.5% blu foron E5R as colourant.

The dyeing temperature used was 98° C. showing optimal dyeability equivalent to the fibres of the pure polybutylen sebacate-co-terephthalate and excellent colour fastness to light.

Sheets have been made with the compositions of examples 1 and 2.

The compositions of Example 1 and 2 were supplied to a twin screw extruder, pelletized at the exit of the extruder and then fed to an injection molding press mod. Sandretto S/7.

The sheets had a thickness of about 1 mm and dimensions of 70 mm×80 mm.

They were painted with a common spray dye Arexons “fai tu color”. The tickness of the dye was about 10μ. In order to guarantee a good adhesion of the dye, the sheets were degreased before applying the dye. The coloured sheets were left at room temperature and 50% RH for 4 hours.

The coloured sheets were then tested with reference to the adhesion of the colour by means of a folding test and a scratching test.

The folding test consisted in three consecutive foldings of the sheets along their median axis.

For each folding, the two non coloured half parts of the sheets were forced to match.

The scratching test consisted in scratching three consecutive times the coloured surface of the sheets with the edge of a metal small plate (such as a coin) inclined at 45° with respect to the sheet coloured surface.

To compare the properties of the compositions according to the present invention, propylene (homopolymer isotactic polypropylene, MFI=25) sheets were made and coloured as above described.

The results are reported in Table 1.

TABLE 1

| Example | Folding test | Scratching test |
|---|---|---|
| 1 | Yes | Yes |
| 2 | Yes | Yes |
| Comparative | No | No |
| (polypropylene) | | |

The results has been visually evaluated in relation to the quantity of dye removed.

Yes: the dye layer wasn't removed from the surface of the sheet at the end of the test;

No: the dye layer was completely removed from the surface of the sheet at the end of the test.

1. Articles comprising a polymeric composition comprising:
from 60 to 99.5% wt of a polyolefin;
from 50 to 0.5% wt of biodegradable aliphatic-aromatic copolyesters of the diacid diol type;
characterized in that said biodegradable aliphatic-aromatic copolyesters contain an aromatic part consisting mainly of terephthalie acid or its derivatives, an aliphatic part consisting of a diacid monomer selected from C₉-C₁₂, and diol C₂-C₁₃,
said articles being selected from the group consisting of films, fibres, fabrics, non-woven fabrics

2. Articles according to claim 1, characterized in that said polyolefin is present in quantity of 80-99% wt and said biodegrable aliphatic-aromatic copolyesters are present in quantity of 1-20% wt with respect to the total weight of the composition.

3. Articles according to claim 1, characterized in that said polyolefin is isotactic polypropylene;

4. Articles according to claim 1, characterized in that said biodegradable aliphatic-aromatic copolyesters have an aromatic acid content with respect to the total acid content of from 30% to 80%.

5. Articles according to claim 4 characterized in that said biodegradable aliphatic-aromatic copolyesters have an aromatic acid content with respect to the total acid content of from 45 to 60%.

6. Articles according to claim 1, characterized in that said dial is C₂-C₄.

7. Articles according to claim 6, characterized in that said diol is butanediol.

8. Articles as claimed in claim 1, characterized in that it comprises one or more additives chosen from antioxidants, UV stabilisers, thermal stabilisers and stabilisers against hydrolysis, flame retardants, slow release agents, inorganic and organic fillers, antistatic agents, wetting agents, colourants and lubricants.

9. Articles according to claim 1, characterized in that said diacid monomer is selected from azeiaic acid, sebacic acid and brassylic acid and their mixtures.

10. Film as claimed in claim 1, selected from the group consisting of blown film or flat sheet die film, said film being as such, oriented or bi-oriented.

11. Film as claimed in claim 10, characterized in that it comprises one or more additives chosen from the group consisting of silica, calcium carbonate, talc, kaolin, kaolinite, zinc oxide, wollastonite, lamellar inorganic substances optionally functionalised with organic molecules and capable of splitting into lamellae during mixing with said polymeric composition or with one of the individual polymers of the mixture to produce nanocomposites.

12. Film as claimed in claim 11, characterized by a concentration of inorganic additives between 0.05 and 70% in weight with respect to the sum of polyolefin and aliphatic-aromatic copolyester.

13. Film as claimed in claim 12, characterized by a concentration of inorganic additives between 0.5 and 50% in weight with respect to the sum of polyolefin and aliphatic-aromatic copolyester.

14. Film as claimed in claim 13, characterized by a concentration of inorganic additives between 1 and 30% in weight with respect to the sum of polyolefin and aliphatic-aromatic copolyester.

15. Film as claimed in claim 14, comprising one or more additives such as natural fibres and fillers.

16. Film as claimed in claim 15, in which the natural fibres or fillers are cellulose fibres, sisal, hazelnut meal, corncobs, rice chaff and soya.

17. Film as claimed in claim 16, in which the natural fibres or loads are present in concentrations between 0.5-70% in weight with respect to the sum of polyolefin and aliphatio-aromatic copolyester.

18. Film as claimed in claim 17, in which the natural fibres or loads are present in concentrations between 1-50% in weight with respect to the sum of polyolefin and aliphatic-aromatio copolyester.

19. Use of non-woven fabric as claimed in claim 1 as a component of nappies, sanitary towels and disposable sanitary articles.

20. Use of sheets as claimed in claim 1 for thermoforming, monoextruded or coextruded with other layers of polymers.

21. Use as claimed in claim 20, for thermoforming of trays for food and containers for agriculture.
